(19) United States
(12) Patent Application Publication
(10) Pub. No.: US 2026/0252287 A1
(43) Pub. Date: Aug. 27, 2026

(54) PRINT SYSTEM, PRINT DEVICE, AND RELAY DEVICE

(71) Applicant: SEIKO EPSON CORPORATION, Tokyo (JP)

(72) Inventors: Hiroyasu FUKAZAWA, MATSUMOTO-SHI (JP); Junichi YOSHIZAWA, MATSUMOTO-SHI (JP); Shunichi WAKASA, CHIKUMA-SHI (JP); Takuto MORI, SHIOJIRI-SHI (JP)

(21) Appl. No.: 19/544,148

(22) Filed: Feb. 19, 2026

(30) Foreign Application Priority Data
Feb. 21, 2025 (JP) 2025-026532

(51) Int. Cl. G06F 3/12

(52) U.S. Cl. CPC G06F 3/1236; G06F 3/1204; G06F 3/1279

(57) ABSTRACT

A print system includes: a relay device configured to communicate with a terminal device; and a print device coupled to the relay device by a USB cable, in which the relay device supplies power to the print device via the USB cable, and when receiving a print instruction from the terminal device, generates print image data based on the print instruction and transmits the generated print image data to the print device via the USB cable, and the print device is driven by the power supplied from the relay device, and prints a print image indicated by the received print image data when receiving the print image data from the relay device.

The present application is based on, and claims priority from JP Application Serial Number 2025-026532, filed February 21, 2025, the disclosure of which is hereby incorporated by reference herein in its entirety.

### BACKGROUND

### 1. Technical Field

The present disclosure relates to a print system, a print device, and a relay device.

### 2. Related Art

In the related art, a print device to which an external device can be coupled is known. For example, JP-A-2023-049561 discloses a print device to which a smart device, a customer display, and a handy scanner can be coupled.

JP-A-2023-049561 is an example of the related art.

However, the print device disclosed in JP-A-2023-049561 has a configuration in which functions overlapping those of the external device or the number of functions can be reduced along with diversification of coupling of the external device or diversification of a data format received from the external device, and there is room for simplification of the configuration.

### SUMMARY

According to an aspect of the present disclosure, a print system includes: a relay device configured to communicate with a terminal device; and a print device coupled to the relay device by a cable, in which the relay device supplies power to the print device via the cable, and when receiving a print instruction from the terminal device, generates print image data based on the print instruction and transmits the generated print image data to the print device via the cable, and the print device is driven by the power supplied from the relay device, and causes a print unit to print a print image indicated by the received print image data when receiving the print image data from the relay device.

According to another aspect of the present disclosure, a print device to be coupled, by a cable, to a relay device communicable with a terminal device, includes: a print unit; and a print device control unit configured to cause the print unit to perform printing with power supplied from the relay device via the cable, in which the print device control unit receives, via the cable from the relay device, print image data generated by the relay device based on a print instruction from the terminal device, and causes the print unit to print the print image indicated by the received print image data.

According to still another aspect of the present disclosure, a relay device communicable with a terminal device and to be coupled to a print device by a cable includes: a relay device control unit, in which the relay device control unit supplies driving power to the print device via the cable, and when receiving a print instruction from the terminal device, generates print image data based on the print instruction and transmits the generated print image data to the print device via the cable.

### BRIEF DESCRIPTION OF THE DRAWINGS

FIG. 1 is a diagram showing a configuration of a print system.

FIG. 2 is a rear perspective view of a relay device.

FIG. 3 is a block diagram showing a configuration of the relay device.

FIG. 4 is a block diagram showing a configuration of a print device.

FIG. 5 is a flowchart showing operations of the relay device and the print device.

FIG. 6 is a sequence diagram showing operations of a terminal device, the relay device, and the print device.

### DESCRIPTION OF EMBODIMENTS

### 1. Configuration of Print System

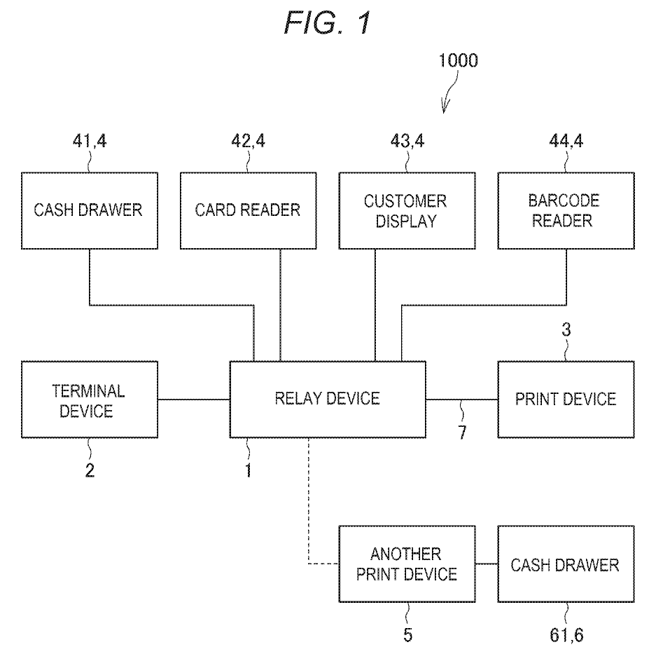

FIG. 1 is a diagram showing a configuration of a print system 1000.

The print system 1000 is a POS (Point of Sale) system for use in a retail business such as a shopping center or a convenience store, or a food and drink business such as a restaurant or a bar. The print system 1000 has, for example, a function of performing accounting according to a commodity purchased by a customer, a function of issuing a receipt according to the accounting, and the like.

The print system 1000 includes a relay device 1, a terminal device 2, and a print device 3.

The relay device 1 is a device that relays communication between the terminal device 2 and the print device 3.

The terminal device 2 is a device that causes the print device 3 to issue a receipt, and transmits a print instruction to the relay device 1. The print instruction is data instructing issuing a receipt. The print instruction includes receipt information including a commodity name, price, and total amount, and control commands related to issuing a receipt.

The print device 3 is a device that accommodates roll paper and performs printing on the accommodated roll paper using a thermal print head 321.

### 2. Configuration of Relay Device

Next, a configuration of the relay device 1 will be described.

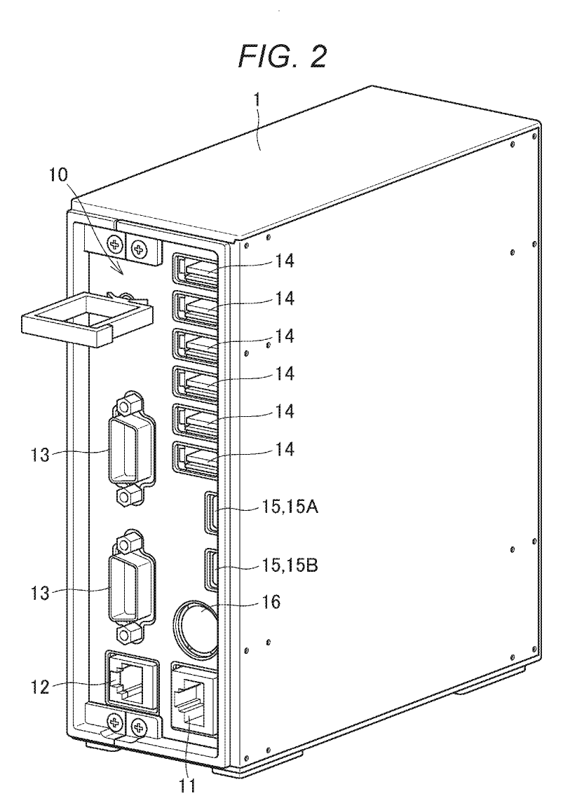

FIG. 2 is a rear perspective view of the relay device 1.

As shown in FIG. 2, the relay device 1 includes an interface 10 to which an external device is coupled.

The interface 10 includes connectors of a plurality of specifications. As shown in FIG. 2, the interface 10 in the embodiment includes a LAN connector 11, a modular connector 12, two serial connectors 13, six USB Type-A connectors 14, and two USB Type-C connectors 15.

The LAN connector 11 is an RJ-45 connector. The relay device 1 is coupled to a communication network via a LAN cable coupled to the LAN connector 11. The communication network is a network implemented by a public switched network, a dedicated line, other communication lines, and various communication facilities, and a specific mode is not limited.

The modular connector 12 is an RJ-11 connector. A peripheral device 4 of the print device 3 is coupled to the modular connector 12. In the embodiment, a case where a cash drawer 41 is coupled to the modular connector 12 is exemplified.

The cash drawer 41 is an example of a "peripheral device of a print device" and an "exclusive control target device".

The serial connector 13 is an RS-232C connector. The peripheral device 4 of the print device 3 is coupled to the serial connector 13. In the embodiment, a case where a card reader 42 is coupled to any of the serial connectors 13 is exemplified. Note that, a device other than the card reader 42 may be coupled to the serial connector 13 together with or instead of the card reader 42.

The card reader 42 is an example of the "peripheral device of the print device".

The peripheral device 4 of the print device 3 is coupled to the USB Type-A connector 14. In the embodiment, a case where a customer display 43 and a barcode reader 44 are coupled to the USB Type-A connector 14 is exemplified. In addition, another print device 5 can be coupled to the USB Type-A connector 14. A peripheral device 6 of the another print device 5 is coupled to the another print device 5. FIG. 1 illustrates a case where a cash drawer 61 is coupled as the peripheral device 6 to the another print device 5.

The customer display 43 and the barcode reader 44 are examples of the "peripheral device of the print device".

The cash drawer 61 is an example of a "peripheral device of another print device".

The terminal device 2 is coupled to a USB Type-C connector 15A among the USB Type-C connector 15.

In addition, the print device 3 is coupled, by a USB cable 7, to a USB Type-C connector 15B among the USB Type-C connector 15.

In addition, as shown in FIG. 2, the interface 10 includes a power supply connector 16. The power supply connector 16 is coupled to a power supply adapter 8. The power supply adapter 8 is a device that converts AC power supplied from a commercial power supply into DC power or into a predetermined voltage.

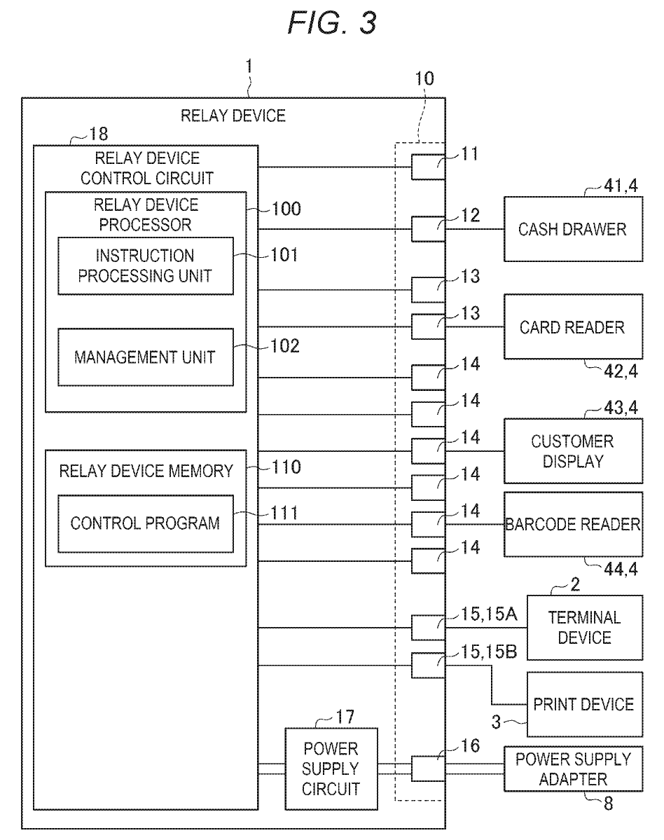

FIG. 3 is a block diagram showing the configuration of the relay device 1.

The relay device 1 includes the interface 10, a power supply circuit 17, and a relay device control circuit 18.

The relay device control circuit 18 is an example of a "relay device control unit".

The power supply circuit 17 supplies power supplied via the power supply connector 16 to each unit of the relay device 1. The power supply circuit 17 in the embodiment supplies the power to the relay device control circuit 18.

The relay device control circuit 18 includes a relay device processor 100, which is a processor such as a central processing unit (CPU) or a micro-processing unit (MPU), a relay device memory 110, and an interface circuit for coupling other devices, and controls each unit of the relay device 1. Each connector of the interface 10 and the power supply circuit 17 are coupled to the relay device control circuit 18.

The relay device memory 110 is a device that stores programs and data. The relay device memory 110 stores a control program 111, data to be processed by the relay device processor 100, and the like. The relay device memory 110 has a nonvolatile storage area. In addition, the relay device memory 110 includes a volatile storage area and constitutes a work area of the relay device processor 100. The relay device memory 110 includes, for example, a read only memory (ROM) or a random access memory (RAM).

When the relay device processor 100 executes the control program 111, the relay device control circuit 18 transmits a control signal to each of the peripheral devices 4 via the interface 10.

In addition, when the relay device processor 100 executes the control program 111, the relay device control circuit 18 communicates with the terminal device 2 and the print device 3 via the interface 10.

In addition, when the relay device processor 100 executes the control program 111 to couple the another print device 5 to the interface 10, the relay device control circuit 18 communicates with the another print device 5 via the interface 10.

In addition, when the relay device processor 100 executes the control program 111, the relay device control circuit 18 supplies the power supplied from the power supply circuit 17 to a device coupled to at least one of the USB Type-A connector 14 and the USB Type-C connector 15.

The relay device control circuit 18 includes an instruction processing unit 101 and a management unit 102

as functional units related to issuing a receipt. The instruction processing unit 101 and the management unit 102 are functional units implemented by the relay device processor 100 executing the control program 111.

The instruction processing unit 101 receives various instructions from the terminal device 2 via the USB Type-C connector 15A. In addition, the instruction processing unit 101 performs processing corresponding to the received instruction.

The management unit 102 communicates with the print device 3 via the USB Type-C connector 15B. In addition, the management unit 102 manages a transmission timing of data to the print device 3. In addition, the management unit 102 manages a transmission timing of a control signal to the peripheral device 4.

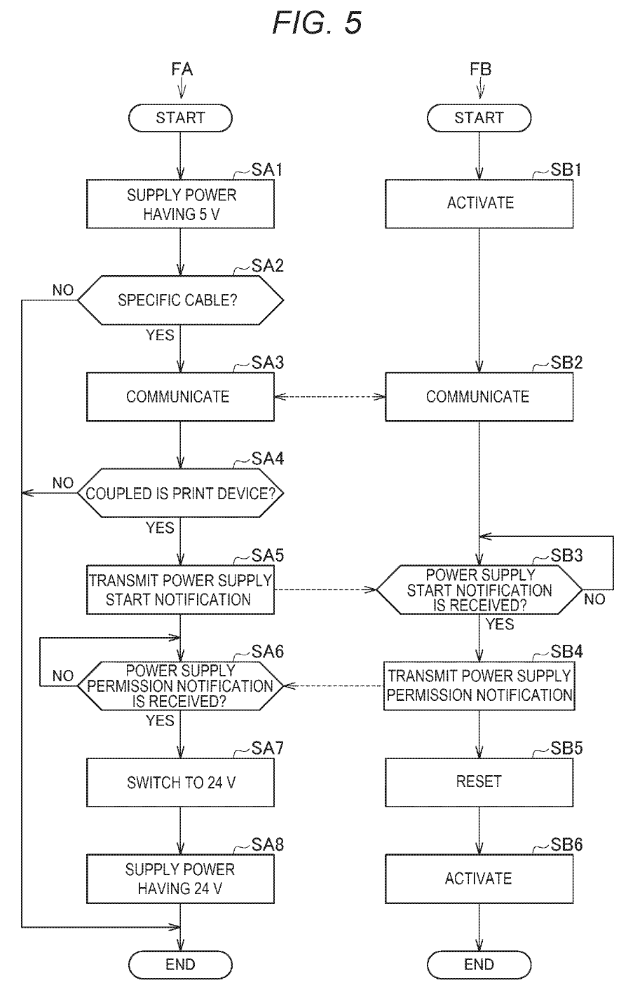

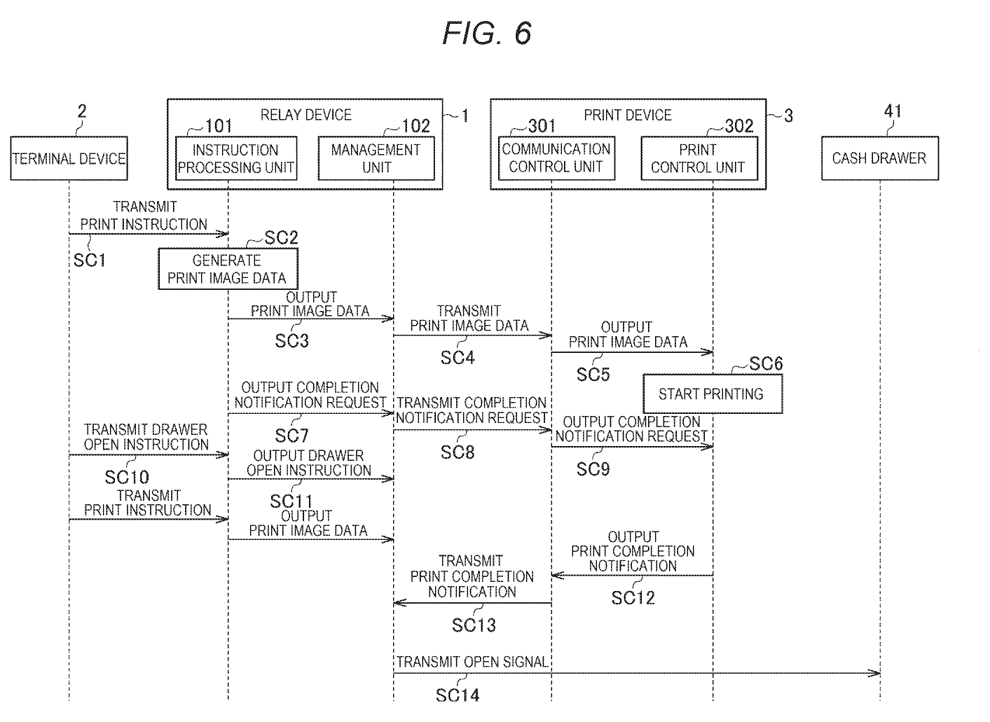

Note that, details of the relay device control circuit 18, the instruction processing unit 101, and the management unit 102 will be further described with reference to FIGS. 5 and 6.

### 3. Configuration of Print Device

Next, a configuration of the print device 3 will be described.

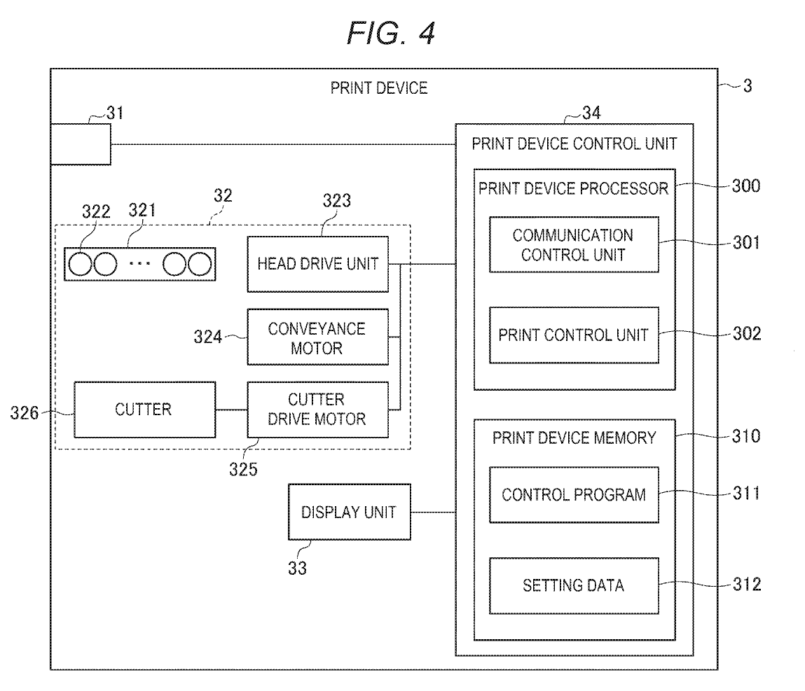

FIG. 4 is a block diagram showing the configuration of the print device 3.

The print device 3 includes a USB Type-C connector 31, a print unit 32, a display unit 33, and a print device control unit 34.

The print unit 32 includes a print head 321, a head drive unit 323, a conveyance motor 324, a cutter drive motor 325, and a cutter 326.

The print head 321 includes a plurality of heat generating elements 322 formed of resistors arranged in a direction intersecting a conveyance direction of the roll paper. The print head 321 generates heat by energizing the heat generating elements 322, and performs printing by applying heat to a printing surface of the roll paper.

The head drive unit 323 includes hardware necessary for driving the print head 321 such as a circuit, and energizes the heat generating elements 322 of the print head 321 according to the control of the print device control unit 34.

The conveyance motor 324 rotates a conveyance roller and conveys the roll paper in the conveyance direction according to the control of the print device control unit 34.

The cutter drive motor 325 drives a movable blade constituting the cutter 326 to slide toward a fixed blade and cuts the roll paper according to the control of the print device control unit 34.

The display unit 33 includes a plurality of light emitting diodes (LEDs). Each of the LEDs provided in the display unit 33 turns on and off under the control of the print device control unit 34.

The print device control unit 34 includes a print device processor 300, which is a processor such as a CPU or an MPU, a print device memory 310, and an interface circuit for coupling other devices, and controls each unit of the print device 3. The USB Type-C connector 31, the print unit 32, and the display unit 33 are coupled to the print device control unit 34.

The print device memory 310 is a device that stores programs and data. The print device memory 310 stores a control program 311, setting data 312, data to be processed by the print device processor 300, and the like. The print device memory 310 has a nonvolatile storage area. The print device memory 310 includes a volatile storage area and constitutes a work area of the print device processor 300. The print device memory 310 includes, for example, a ROM and a RAM.

The setting data 312 is data related to setting of the print device 3 and includes a plurality of setting items. The setting data 312 in the embodiment includes a setting item for enabling or disabling execution of a print function. In this setting item, a setting value indicating that the execution of the print function is enabled or a setting value indicating that the execution of the print function is disabled is set.

The print device control unit 34 executes various operations by the print device processor 300 reading and executing the control program 311.

The print device control unit 34 has a communication control unit 301 and a print control unit 302 as function units related to issuing a receipt. The communication control unit 301 and the print control unit 302 are functional units implemented by the print device processor 300 executing the control program 311.

The communication control unit 301 receives print image data from the relay device 1 via the USB Type-C connector 31. The print image data is data indicating a print image to be printed on a receipt. The print image data includes a print image in a raster format. The print image data also includes data related to issuing a receipt, such as a cut position of a print medium.

In addition, the communication control unit 301 transmits a print completion notification to the relay device 1 via the USB Type-C connector 31. The print completion notification is data indicating that the printing is completed.

Based on the print image data, the print control unit 302 causes the print unit 32 to perform printing to issue a receipt.

Note that, details of the print device control unit 34, the communication control unit 301, and the print control unit 302 will be further described with reference to FIGS. 5 and 6.

### 4. Operation

Next, an operation of each unit in the print system 1000 will be described.

### 4-1. Operation When Coupling Relay Device and Print Device

First, an operation when coupling the relay device 1 and the print device 3 will be described with reference to FIG. 5.

FIG. 5 is a flowchart showing operations of the relay device 1 and the print device 3. In FIG. 5, a flowchart FA shows the operation of the relay device 1, and a flowchart FB shows the operation of the print device 3.

When the relay device 1 and the print device 3 are to be coupled by the USB cable 7, the relay device control circuit 18 supplies power having 5 V to the print device 3 via the USB Type-C connector 15B (step SA1). Then, the print device control unit 34 receives the power having 5 V from the relay device 1 and activates the print device 3 (step SB1).

The power having 5 V is an example of "power having a first voltage".

Note that, when the print device 3 is activated, the print device control unit 34 notifies that the power having 5 V is supplied by turning on the LED of the display unit 33.

Next, the relay device control circuit 18 determines whether the USB cable 7 coupled to the USB Type-C connector 15B is a specific cable (step SA2). Here, the

specific cable refers to a cable capable of supplying power having 24 V. For example, the specific cable is a cable having maximum supply power of 240 W. In step SA2, the relay device control circuit 18 determines whether the USB cable 7 coupled to the USB Type-C connector 15B is a specific cable by obtaining the type of the USB cable 7 from an integrated circuit (IC) chip built in the USB cable 7.

When it is determined that the USB cable 7 is not a specific cable (step SA2: NO), the relay device control circuit 18 ends this processing. Note that, while the USB cable 7 is coupled to the USB Type-C connector 15B, the relay device control circuit 18 supplies the power having 5 V via the USB Type-C connector 15B even when it is determined that the USB cable 7 is not a specific cable in step SA2.

On the other hand, when it is determined that the USB cable 7 is a specific cable (step SA2: YES), the relay device control circuit 18 communicates with the print device 3 via the USB Type-C connector 15B (step SA3). In addition, when it is determined that the USB cable 7 is a specific cable, the print device control unit 34 communicates with the relay device 1 via the USB Type-C connector 31 (step SB2).

In the communication in step SA3 and step SB2, a product ID and a vendor ID are transmitted from the print device 3 to the relay device 1, and a product ID and a vendor ID are transmitted from the relay device 1 to the print device 3.

The relay device control circuit 18 determines whether a device coupled by the USB cable 7 is the print device 3 based on the product ID and the vendor ID received in the communication in step SA3 (step SA4).

When it is determined that the device coupled by the USB cable 7 is not the print device 3 (step SA4: NO), the relay device control circuit 18 ends this processing. Note that, while the USB cable 7 is coupled to the USB Type-C connector 15B, the relay device control circuit 18 supplies the power having 5 V via the USB Type-C connector 15B even when it is determined that the device coupled by the USB cable 7 is not the print device 3 in step SA4.

On the other hand, when it is determined that the device coupled by the USB cable 7 is the print device 3 (step SA4: YES), the relay device control circuit 18 transmits a power supply start notification to the print device 3 via the USB Type-C connector 15B (step SA5). The power supply start notification is data for notifying the start of power supply.

As shown in FIG. 5, the print device control unit 34 determines whether the power supply start notification is received (step SB3). When it is determined that the power supply start notification is not received (step SB3: NO), the print device control unit 34 performs step SB3 again.

On the other hand, when it is determined that the power supply start notification is received (step SB3: YES), the print device control unit 34 transmits a power supply permission notification to the relay device 1 via the USB Type-C connector 31 (step SB4). The power supply permission notification is data for notifying the permission of power supply.

As shown in FIG. 5, the relay device control circuit 18 determines whether the power supply permission notification is received (step SA6). When it is determined that the power supply permission notification is not received (step SA6: NO), the relay device control circuit 18 performs the determination in step SA6 again.

On the other hand, when it is determined that the power supply permission notification is received (step SA6: YES), the relay device control circuit 18 switches the voltage of the power supplied via the USB Type-C connector 15B from 5 V to 24 V (step SA7).

The power having 24 V is an example of "power having a second voltage".

As shown in FIG. 5, when the power supply permission notification is transmitted, the print device control unit 34 resets the system of the print device 3 (step SB5). More specifically, the print device control unit 34 restarts the print device 3 in step SB5.

Note that, the processing in step SA7 and the processing in step SB5 may be performed simultaneously, may be performed in the order of step SA7 and step SB5, or may be performed in the reverse order.

In addition, as shown in FIG. 5, the relay device control circuit 18 supplies the power having 24 V to the print device 3 via the USB Type-C connector 15B (step SA8). Then, the print device control unit 34 receives the supply of the power having 24 V from the relay device 1 and activates the print device 3 (step SB6). Note that, when the print device 3 is activated, the print device control unit 34 notifies that the power having 24 V is supplied by turning on the LED of the display unit 33. A mode of the notification is different from a mode of the notification that the power having 5 V is supplied.

As described above, when the USB cable 7 is coupled to the USB Type-C connector 15B, the relay device 1 supplies the power having 5 V. Then, when the device coupled to the USB Type-C connector 15B is the print device 3, the relay device 1 switches the power to be supplied from the power having 5 V to the power having 24 V. Accordingly, when a device that does not support the power having 24 V is coupled to the USB Type-C connector 15B, it is possible to prevent a voltage equal to or larger than a rated voltage from being supplied to the device.

Note that, the print device 3 determines whether the device coupled by the USB cable 7 is the relay device 1, and enables the execution of the print function when it is determined that the device is the relay device 1. More specifically, the print device control unit 34 determines whether the device coupled to the USB cable 7 is the relay device 1 based on the product ID and the vendor ID received in step SB2. Then, when it is determined that the device coupled to the USB cable 7 is the relay device 1, the print device control unit 34 enables the execution of the print function by changing the setting value of the setting data 312. Accordingly, the print device 3 can perform printing when coupled to the relay device 1. Therefore, the print device 3 does not perform printing in a state of being erroneously coupled to a device other than the relay device 1. Therefore, it is possible to prevent a situation in which the print device 3 draws in power necessary for printing from a device other than the relay device 1 that is erroneously coupled.

Then, when the relay device 1 starts supplying the power having 24 V, the relay device 1 notifies the terminal device 2 that the relay device 1 and the print device 3 are coupled thereto. More specifically, the relay device control circuit 18 transmits the product ID and the vendor ID received in the communication in step SA3 and the product ID and the vendor ID of the relay device 1 to the terminal device 2. Accordingly, the terminal device 2 can recognize that the relay device 1 and the print device 3 are coupled thereto, and can perform various instructions while distinguishing the relay device 1 and the print device 3.

### 4-2. Operation Related to Issuing Receipt

The print device 3 is driven by the power having 24 V to issue a receipt.

Next, an operation related to issuing a receipt will be described with reference to FIG. 6.

FIG. 6 is a sequence diagram showing operations of the terminal device 2, the relay device 1, and the print device 3.

In issuing a receipt, the terminal device 2 transmits a print instruction to the relay device 1 (step SC1).

When receiving the print instruction from the terminal device 2, the instruction processing unit 101 of the relay device 1 generates print image data based on the print instruction (step SC2). In step SC2, the instruction processing unit 101 generates the print image data by performing processing such as rasterization based on the print instruction.

Next, the instruction processing unit 101 outputs the generated print image data to the management unit 102 (step SC3).

The management unit 102 transmits the received print image data to the print device 3 via the USB Type-C connector 15B (step SC4).

When receiving the print image data from the relay device 1, the communication control unit 301 of the print device 3 outputs the received print image data to the print control unit 302 (step SC5).

Next, the print control unit 302 starts printing based on the received print image data (step SC6).

As shown in FIG. 6, after outputting the print image data, the instruction processing unit 101 of the relay device 1 outputs a completion notification request to the management unit 102 (step SC7). The completion notification request is data for requesting a print completion notification.

When receiving the completion notification request, the management unit 102 transmits the completion notification request to the print device 3 via the USB Type-C connector 15B (step SC8).

When receiving the completion notification request, the communication control unit 301 of the print device 3 outputs the received completion notification request to the print control unit 302 (step SC9). Accordingly, when the printing is completed, the print control unit 302 outputs the print completion notification. That is, the print control unit 302 outputs the print completion notification when the issuing a receipt ends.

As shown in FIG. 6, when transmitting a print instruction, the terminal device 2 transmits a drawer open instruction to the relay device 1 (step SC10). The drawer open instruction transmitted in step SC10 is data indicating a control instruction for the cash drawer 41, and indicates an instruction to open the cash drawer 41.

When receiving the drawer open instruction, the instruction processing unit 101 of the relay device 1 outputs the received drawer open instruction to the management unit 102 (step SC11).

The management unit 102 receives the drawer open instruction, but suspends transmission of an open signal to the cash drawer 41 since the printing by the print device 3 is not completed. Note that, the open signal is a control signal to open the cash drawer 41.

FIG. 6 illustrates a case where the terminal device 2 further transmits the print instruction after the drawer open instruction. In the relay device 1, print image data is generated based on the print instruction, and the generated print image data is output to the management unit 102. However, the management unit 102 does not control the cash drawer 41 based on the drawer open instruction, and thus suspends the transmission of the received print image data.

As shown in FIG. 6, when the print device 3 issues a receipt, the print control unit 302 outputs the print completion notification to the communication control unit 301 (step SC12). Then, the communication control unit 301 transmits the print completion notification to the relay device 1 via the USB Type-C connector 31 (step SC13).

When receiving the print completion notification, the management unit 102 of the relay device 1 transmits the suspended open signal via the modular connector 12 (step SC14).

As described above, the print device 3 is driven by the power supplied via the USB cable 7 to issue a receipt. Therefore, the print device 3 can issue a receipt without a power supply adapter such as an AC adapter. Therefore, a power supply adapter is not required in the print device 3, and the configuration of the print device 3 can be simplified. In addition, since the communication and the power supply can be performed by one USB cable 7, the number of connectors provided in the print device 3 can be reduced and the configuration of the print device 3 can be simplified. Further, since the communication and the power supply can be performed by one USB cable 7, the configuration of the print system 1000 can be simplified.

The relay device 1 generates the print image data and transmits the print image data to the print device 3. Then, the print device 3 issues a receipt based on the received print image data. In the related art, a print device generates print image data, but the print device 3 does not need to perform the processing of generating the print image data. Therefore, a configuration for performing the processing of generating the print image data is not required in the print device 3, and the configuration of the print device 3 can be simplified.

### 4-3. Transmission of Control Signal to Peripheral Device

As described above, the another print device 5 can be coupled to the relay device 1. The cash drawer 61 is coupled as the peripheral device 6 to the another print device 5. Therefore, the relay device 1 outputs a control signal from the modular connector 12 when opening the cash drawer 41, and causes the another print device 5 to open the cash drawer 61 when opening the cash drawer 61.

When the terminal device 2 transmits the drawer open instruction, the management unit 102 receives the drawer open instruction as shown in FIG. 6. The drawer open instruction includes, as information, an instruction addressed to the print device 3 or an instruction addressed to the another print device 5. In the case of the instruction addressed to the print device 3, the management unit 102 opens the cash drawer 41 by transmitting the control signal from the modular connector 12. In the case of the instruction addressed to the another print device 5, the management unit 102 does not transmit the control signal from the modular connector 12. In this case, the management unit 102 transmits a control instruction to open the cash drawer 61 to the another print device 5 via the interface 10. Accordingly, the another print device 5 opens the coupled cash drawer 61 by transmitting a control signal from a connector coupled to the cash drawer 61.

Accordingly, it is possible to provide the print system 1000 capable of controlling the cash drawer 61 coupled to the another print device 5.

### 5. Other Embodiments

The embodiment described above is a preferred embodiment of the present disclosure. However, the present disclosure is not limited to the embodiment described above, and various modifications are conceivable to the extent that the modifications do not depart from the key points of the present disclosure.

In the embodiment described above, the cash drawer 41 is exemplified as the exclusive control target device controlled at a timing different from a timing of the printing by the print device 3. However, the exclusive control target device is not limited to the cash drawer 41 and may be any device controlled at a timing different from the timing of the printing by the print device 3. For example, the exclusive control target device may be a buzzer.

In the embodiment described above, when the control instruction for the cash drawer 41 is received from the terminal device 2, the relay device 1 transmits the control signal to the cash drawer 41 via the interface 10. In addition, in the embodiment described above, when the control instruction for the cash drawer 61 is received from the terminal device 2, the relay device 1 transmits the control instruction for the cash drawer 61 to the another print device 5 via the interface 10. However, the mode of transmitting the control signal and the control instruction is not limited to the cash drawers 41, 61. The relay device 1 may perform similar transmission to the peripheral devices 4, 6 other than the cash drawers 41, 61.

In the embodiment described above, 5 V is exemplified as the "first voltage", and 24 V is exemplified as the "second voltage". However, the "first voltage" is not limited to 5 V, and may be a voltage smaller than the "second voltage". The "second voltage" is not limited to 24 V, and may be a voltage larger than the "first voltage". However, the power having the "second voltage" is equal to or larger than the power consumed in the printing by the print device 3.

In the embodiment described above, the USB cable 7 is exemplified as the "cable". However, the "cable" is not limited to the USB cable 7 as long as the relay device 1 can supply power to the print device 3 and the relay device 1 and the print device 3 can communicate with each other.

In the embodiment described above, the print device 3 including the thermal print head 321 is exemplified as the "print device". However, the printing method by the "print device" is not limited to the thermal method, and may be another method such as an inkjet method.

In the embodiment described above, a case where the "print system" is the print system 1000 for use in a retail business such as a shopping center or a convenience store, or a food and drink business such as a restaurant or a bar has been exemplified. However, the application of the "print system" is not limited to the POS system.

The functions of the relay device processor 100 and the print device processor 300 may be implemented by a plurality of processors or semiconductor chips.

Each unit of the relay device 1 shown in FIG. 3 and each unit of the print device 3 shown in FIG. 4 indicate a functional configuration, and a specific implementation form is not particularly limited. That is, it is not necessary to mount hardware individually corresponding to each functional unit, and one processor may execute a program to implement a plurality of functions. Some of functions implemented by software in the embodiment described above may be implemented by hardware and some of functions implemented by hardware may be implemented by software. In addition, specific detailed configurations of other units of the relay device 1 and the print device 3 can be optionally changed without departing from the gist of the present disclosure.

The processing unit in the flowchart shown in FIG. 5 and the processing unit of the sequence diagram shown in FIG. 6 are divided according to the main processing content in order to facilitate understanding of the processing of each unit of the print system 1000. Therefore, the present disclosure is not limited by the way of dividing the processing units or the names thereof. The processing unit may be divided into more step units according to the processing content. In addition, one step unit may include many pieces of processing. In addition, the order of the steps may be changed appropriately without causing any problem to the gist of the present disclosure.

### 6. Summary of Present Disclosure

The present disclosure will be summarized below as appendices.

Appendix 1

A print system including: a relay device configured to communicate with a terminal device; and a print device coupled to the relay device by a cable, in which the relay device supplies power to the print device via the cable, and when receiving a print instruction from the terminal device, generates print image data based on the print instruction and transmits the generated print image data to the print device via the cable, and the print device is driven by the power supplied from the relay device, and prints a print image indicated by the received print image data when receiving the print image data from the relay device.

Accordingly, the print device can be driven even when a power supply adapter is not externally coupled, and printing can be performed even when a configuration for generating the print image data is not provided. Therefore, the power supply adapter and the configuration for generating the print image data are not required in the print device, and the configuration of the print device can be simplified.

Appendix 2

The print system according to Appendix 1, in which the relay device includes an interface to which a peripheral device of the print device is coupled, and transmits a control signal to the peripheral device of the print device via the interface.

Accordingly, since the relay device can control the peripheral device of the print device, a configuration for communicating with the peripheral device such as a connector is not required in the print device, and the configuration of the print device can be further simplified.

Appendix 3

The print system according to Appendix 2, in which another print device different from the print device is couplable to the interface, and the relay device transmits a control signal to the peripheral device of the print device via the interface when receiving a control instruction for the peripheral device of the print device from the terminal device, and transmits, to the other print device via the interface, a control instruction for a peripheral device coupled to the other print device when receiving the control instruction for the peripheral device coupled to the other print device from the terminal device.

Accordingly, it is possible to provide a print system capable of controlling the peripheral device coupled to the other print device.

Appendix 4

The print system according to any one of Appendix 1 to Appendix 3, in which the relay device supplies power having a first voltage via the cable, determines whether a device coupled by the cable is the print device, and supplies power having a second voltage larger than the first voltage via the cable when it is determined that the device coupled by the cable is the print device, and the print device is driven by the power having a second voltage to perform printing.

Accordingly, when a device that does not support the power for driving the print device is coupled to the relay device, it is possible to prevent a voltage equal to or larger than a rated voltage from being supplied to the device.

Appendix 5

The print system according to Appendix 4, in which the print device determines whether a device coupled by the cable is the relay device, and enables execution of a print function when it is determined that the device coupled by the cable is the relay device.

Accordingly, the print device can perform printing when coupled to the relay device. Therefore, the print device does not perform printing in a state of being erroneously coupled to a device other than the relay device. Therefore, it is possible to prevent a situation in which the print device draws in power necessary for printing from a device other than the relay device that is erroneously coupled.

Appendix 6

The print system according to Appendix 2 or Appendix 3, in which as the peripheral device of the print device, an exclusive control target device, which is controlled at a timing different from a timing of printing by the print device, is coupled to the interface, and the relay device suspends transmission of a control signal to the exclusive control target device while the print device is executing the printing, and transmits the control signal to the exclusive control target device via the interface when the printing by the print device is completed.

Accordingly, even when the exclusive control target device is coupled to the relay device separate from the print device, the exclusive control target device can be exclusively controlled for the printing by the print device.

Appendix 7

The print system according to Appendix 6, in which the print device transmits a print completion notification to the relay device when the printing is completed, and the relay device transmits the control signal to the exclusive control target device when receiving the print completion notification from the print device.

Accordingly, since the exclusive control target device is controlled in response to the reception of the print completion notification, the exclusive control target device can be appropriately exclusively controlled for the printing by the print device.

Appendix 8

The print system according to any one of Appendix 1 to Appendix 7, in which when the relay device is coupled to the print device by the cable, the relay device transmits, to the terminal device, that the relay device and the print device are coupled to the terminal device.

Accordingly, the terminal device can recognize that the print device and the relay device are coupled to the terminal device.

Appendix 9

A print device to be coupled, by a cable, to a relay device communicable with a terminal device, the print device including: a print unit; and a print device control unit configured to cause the print unit to perform printing with power supplied from the relay device via the cable, in which the print device control unit receives, from the relay device via the cable, print image data generated by the relay device based on a print instruction from the terminal device, and causes the print unit to print a print image indicated by the received print image data.

Accordingly, effects same as those of the print system according to Appendix 1 are achieved.

Appendix 10

A relay device communicable with a terminal device and to be coupled to a print device by a cable, the relay device including: a relay device control unit, in which the relay device control unit supplies driving power to the print device via the cable, and when receiving a print instruction from the terminal device, generates print image data based on the print instruction and transmits the generated print image data to the print device via the cable.

Accordingly, effects same as those of the print system according to Appendix 1 are achieved.

What is claimed is:

1. A print system comprising:
a relay device configured to communicate with a terminal device; and
a print device coupled to the relay device by a cable, wherein
the relay device
supplies power to the print device via the cable, and
when receiving a print instruction from the terminal device, generates print image data based on the print instruction and transmits the generated print image data to the print device via the cable, and
the print device
is driven by the power supplied from the relay device, and
prints a print image indicated by the received print image data when receiving the print image data from the relay device.

2. The print system according to claim 1, wherein
the relay device includes an interface to which a peripheral device of the print device is coupled, and transmits a control signal to the peripheral device of the print device via the interface.

3. The print system according to claim 2, wherein
another print device different from the print device is couplable to the interface, and
the relay device
transmits a control signal to the peripheral device of the print device via the interface when receiving a control instruction for the peripheral device of the print device from the terminal device, and
transmits, to the other print device via the interface, a control instruction for a peripheral device coupled to the other print device when receiving the control instruction for the peripheral device coupled to the other print device from the terminal device.

4. The print system according to claim 1, wherein
the relay device
supplies power having a first voltage via the cable,
determines whether a device coupled by the cable is the print device, and
supplies power having a second voltage larger than the first voltage via the cable when it is determined that the device coupled by the cable is the print device, and
the print device is driven by the power having a second voltage to perform printing.

5. The print system according to claim 1, wherein
the print device
determines whether a device coupled by the cable is the relay device, and
enables execution of a print function when it is determined that the device coupled by the cable is the relay device.

6. The print system according to claim 2, wherein
as the peripheral device of the print device, an exclusive control target device, which is controlled at a timing different from a timing of printing by the print device, is coupled to the interface, and
the relay device suspends transmission of a control signal to the exclusive control target device while the print device is executing the printing, and transmits the control signal to the exclusive control target device via the interface when the printing by the print device is completed.

7. The print system according to claim 6, wherein
the print device transmits a print completion notification to the relay device when the printing is completed, and
the relay device transmits the control signal to the exclusive control target device when receiving the print completion notification from the print device.

8. The print system according to claim 1, wherein
when the relay device is coupled to the print device by the cable, the relay device transmits, to the terminal device, that the relay device and the print device are coupled to the terminal device.

9. A print device to be coupled, by a cable, to a relay device communicable with a terminal device, the print device comprising:
a print unit; and
a print device control unit configured to cause the print unit to perform printing with power supplied from the relay device via the cable, wherein
the print device control unit
receives, from the relay device via the cable, print image data generated by the relay device based on a print instruction from the terminal device, and
causes the print unit to print a print image indicated by the received print image data.

10. A relay device communicable with a terminal device and to be coupled to a print device by a cable, the relay device comprising:
a relay device control unit, wherein
the relay device control unit
supplies driving power to the print device via the cable, and
when receiving a print instruction from the terminal device, generates print image data based on the print instruction and transmits the generated print image data to the print device via the cable.
